(19) United States
(12) Patent Application Publication
(10) Pub. No.: US 2010/0059988 A1
(43) Pub. Date: Mar. 11, 2010

(54) LOOSE FLANGE PIPE JOINT

(75) Inventors: Shigeyuki Matsumoto, Tokyo (JP); Susumu Hotta, Tokyo (JP)

Correspondence Address: Kirschstein, Israel, Schiffmiller & Pieroni, P.C., 425 FIFTH AVENUE, 5TH FLOOR, NEW YORK, NY, 10016-2223, US

(73) Assignee: NOWLA ENGINEERING CO., LTD., Tokyo (JP)

(21) Appl. No.: 12/528,535

(22) PCT Filed: Aug. 11, 2008
(86) PCT No.: PCT/JP2008/064403

§ 371 Date: Aug. 25, 2009

(30) Foreign Application Priority Data
Aug. 27, 2007 (JP) 2007-006617
Mar. 7, 2008 (JP) 2008-001321
Aug. 11, 2008 (WO) 2009/028322 A1

(51) Int. Cl. F16L 23/024; F16L 17/06

(52) U.S. Cl. 285/148.28; 277/608

(57) ABSTRACT

The loose-flange type fitting according to the present invention is closely sealed with an elastic gasket whose both the sides and outer circumferential face are pressed against a pipe collars and a reinforcing ring so that the seal contact therebetween increases in degree together with rising of a tubeside internal pressure, in which the seal material comprising an annular elastic gasket, a metallic reinforcing ring disposed on the outer circumferential side of the elastic gasket and the inner circumferential face of the elastic gasket having substantially a V-shaped cross-section and the axial width of the gasket being broader than that of the reinforcing ring under non-compression conditions.

### TECHNICAL FIELD

The present invention relates to a loose-flange type fitting in which both the sides and outer circumferential face of an elastic gasket are pressed against a pipe collars and a reinforcing ring so that the seal contact therebetween increases in degree together with rising of a tubeside internal pressure.

### BACKGROUND ART

In a plumbing such as water-supply or air-conditioning works, a piping diagram is designed prior to a piping operation, and subsequently metallic pipes are previously connected and/or bent in a factory on the base of this piping diagram. So as to connect linearly metallic pipes to each other, a flanged type fitting is preferable in terms of the mechanical strength of connecting section, a piping operation for a large-diameter pipe or the like. In a stationary flange type fitting, the flange is welded on the edge of the pipe, therefore it is not easy to match bolt holes of both the flanges with each other during piping works. The bolt holes must be matched even if each one of the metallic pipes is twisted forcibly, which tends to cause an operation delay and pipe damage.

A loose-flange type fitting is, for example, disclosed in the drawings attached in JP-H09-14545, which is easy to match the bolt holes with each other as compared with the a stationary flange type fitting. As exemplified in FIG. 13, a loose flange 100 is independent of metallic pipes 102, 102. Each loose flange 100 is fitted onto the pipes 102, 102 and subsequently a stub end is welded on the pipe edge or pipe edge portion is flanged. On each flange 100, two or more bolt holes 104 are formed at equal intervals in the circumferential direction. The surfaces of two pipe collars 106, 106 are matched with each other via a sheet packing 108. Each bolt 110 is passed through the holes 104, 104, onto which each nut is screwed. The packing 108 is generally made of hard plastics, hard rubber or the like, which is softer than a body of the metallic pipe. The packing 108 tends to cause plastic deformation while a tubeside pressure is high or negative. It is therefore necessary to define the packing 108 with about the same surface area as that of the collar 106, as shown in FIG. 13, so that the packing 108 is not deformed with friction resistance.

In a conventional loose-flange type fitting, the bolts 110 must be tightened excessively so as to secure high sealing between the pipes 102, 102 with the sheet packing 108. It is feared that the packing 108 cracks under a hard tightening of these bolts and nuts and thus a water leak is generated. It is also necessary that the loose flange 100 has high mechanical strength owing to a hard tightening. It is hard to secure a workspace within the operation place owing to heavy weight and large outside diameter of the flange.

In a loose-flange type fitting, it is a well-known matter to use an O-ring together with a packing so as to obtain high sealing between both pipes, as disclosed in JP-H09-14545-A, JP-H04-133430-U or the like. JP-H09-14545-A teaches that the O-ring is disposed on the inner circumferential side of a packing in attached FIG. 4 and the outside diameter of the packing is substantially equal to the outside diameter of the loose flange. Meanwhile, JP-H04-133430-U teaches that the O-ring is disposed on the inner circumferential side of an outer ring corresponding to a packing in attached FIG. 2 and the outside diameter of the outer ring is larger than the outside diameter of a pipe collar.
[Cited Reference 1] JP-H09-14545-A
[Cited Reference 2] JP-H04-133430-U

### DISCLOSURE OF INVENTION

### Problems to be Solved by the Invention

As disclosed in JP-H09-14545-A and JP-H04-133430-U, the O-ring used together with the loose flange is mounted to insert in a circular groove. Though a sealing between both pipes can be relatively raised, the sealing is not such high as to prevent an excessive tightening of bolts and nuts. The sealing is almost similar in need of a hard tightening to a conventional fitting. This O-ring is generally an elastic material having an annular cross section. There is therefore a problem that the O-ring tends to be deformed inward and thus a sealing between both pipes decreases more or less when the tubeside pressure becomes negative.

In JP-H09-14545-A, the outside diameter of a packing is nearly equal to the outside diameter of a loose flange, the weight of the flange is heavy according to the size thereof, and also the outside diameter of the flange is large. Thus it is hard to secure a workspace within the operation owing to heavy weight and large outside diameter of the flange. Meanwhile, in JP-H04-133430-U, the outside diameter of an outer ring corresponding to a packing is larger than the outside diameter of a pipe collar and also the axial width of the outer ring is considerably large, however a raw material thereof is not clear. It is expensive and troublesome to process the outer ring. It is also difficult to locate securely the outer ring during mounting.

The present invention is proposed to improve the problem above-mentioned concerning a conventional loose-flange type fitting. It is therefore an object to provide a loose-flange type fitting in which the sealing with an elastic gasket increases in degree together with rising of a tubeside internal pressure.

It is another object of the present invention to provide a loose-flange type fitting in which the number of the locking bolt may be reduced nearly in one half from a conventional fitting and the width and the outside diameter of the loose flange may be smaller relatively because hard tightening with bolts and nuts is not necessary.

It is another object of the present invention to provide a loose-flange type fitting that is easy to secure a workspace within the operation place.

It is another object of the present invention to provide a loose-flange type fitting in which the gasket is not deformed inward and thus a sealing between both the pipes does not decrease in degree when the tubeside pressure becomes negative.

It is a further object of the present invention to provide a fitting assembly that is comparatively inexpensive and is able to build in an existing plumbing.

### Means for Solving the Problem

In a loose-flange type fitting according to the present invention, each edge of both pipes may be flanged or each stub end may be welded to the ends thereof and then both fitted loose flanges are connected and locked up to each other while a seal material is arranged between the end faces of both the pipes. The seal material comprises an annular elastic gasket, a metallic reinforcing ring disposed on the outer circumferential side of the elastic gasket and the inner circumferential face of the elastic gasket having substantially a V-shaped cross-section and the axial width of the gasket being broader than that of the reinforcing ring under non-compression conditions.

It is preferable that the transverse section of the elastic gasket is a rectangle having V-shaped lips on the inner circumferential side thereof in the fitting according to the present invention. The reinforcing ring has preferably a rectangular section, whose axial width is smaller than that of the elastic gasket by a compressed portion of the gasket, the axial width thereof being 50 to 95% of that of the gasket. It is also preferable that the thickness of the reinforcing ring is defined as a thickness having the same or higher strength as the thickness of the connection pipe.

As for the fitting of the present invention, at least one extension that projects outward in the diametric direction may be formed on the reinforcing ring, a bolt-penetrating hole being bored in the extension. For example, two extensions that project outward in the diametric direction may be formed on the reinforcing ring.

As for the fitting of the present invention, each round recess may be formed on the inner end face of the loose flanges, the depth of the round recess being substantially equal or smaller to the addition of the thickness of the pipe collar and a half of the thickness of the reinforcing ring. For example, both the loose flanges may be locked up while each pipe collar is inserted in the round recess of the loose flange and then the elastic gasket and the reinforcing ring are arranged between two collars when assembling.

It is preferable that the reinforcing ring is made of stainless steel, carbon steel or cast steel in the fitting of the present invention. It is also preferable that the elastic gasket is made of rubber or plastics.

In the fitting of the present invention, a metallic supporting ring may be arranged on the inner circumferential side of the elastic gasket so that it prevents the elastic gasket from being deformed inward. The supporting ring is preferably made of stainless steel, carbon steel or cast steel, the supporting ring having a circular or rectangular cross-section.

A seal material may be arranged between collars of both stub ends and then both fitted loose flanges are connected and locked up to each other. The seal material comprises an annular elastic gasket, a metallic reinforcing ring disposed on the outer circumferential side of the elastic gasket and the inner circumferential face of the elastic gasket having substantially a V-shaped cross-section and the axial width of the gasket under non-compression conditions being broader than that of the reinforcing ring. Both the stub ends are finally welded to the ends of the pipes, whereby the fitting assembly is built in a plumbing arrangement.

The seal material comprises an annular elastic gasket, a metallic reinforcing ring disposed on the outer circumferential side of the elastic gasket and a metallic supporting ring disposed on the inner circumferential face of the elastic gasket. The supporting ring may be arranged so that it prevents the elastic gasket from an inward deformation. It is preferable that the supporting ring is made of stainless steel, carbon steel or cast steel, the supporting ring having a circular or rectangular cross-section.

Referring to the attached drawings for the present invention, connection pipes 3 and 3 are generally metallic or plastic conduits having like or similar diameters in a loose-flange type fitting 1 or 34. Conduits having different diameters or a set of metallic and plastic conduits may be applied to these pipes 3, 3. It is possible to make the pipes 3 and the flange 2 out of various kinds of metals, preferably the pipe 3 is carbon steel or stainless steel-made and the flange 2 is stainless steel, carbon steel or cast steel-made. In case of the carbon steel-made or cast steel-made, it is desirable to take anticorrosion measures such as zinc galvanizing, resin coating or the like.

The loose flange 2 or 36 has a doughnut-shaped plane as shown in FIG. 2, on which three, four or six bolt holes 5 are arranged at regular intervals in the circumferential direction. The loose flange 2 has generally a round-shaped plane, however it possible to make dents in the circumference of the flange 2 except portions 26 where the bolt holes 5 exist, as shown in FIG. 2 or 8, so that the whole area of the fitting 1 becomes compact. The shape of the loose flange 2 may be substantially a square, a triangle or the like. As for the loose flange 2, the inside diameter thereof, namely, the diameter of a central hole may be substantially the same or slightly larger as the outside diameter of the pipe 2 to be connected. The thickness of the loose flange may be nearly equal to that of a conventional flange if a round recess 38 (FIG. 7) is not formed. Also thicker loose flanges may be applied when they need to be locked up under higher pressure.

As shown in FIG. 7 or 8, the round recess 38 may be formed on the inside face of for the loose flange, whose diameter is so defined that it is substantially the same or slightly larger as the outside diameter of the pipe collar 7 and a circular reinforcing ring 42 (FIG. 9). The depth of the round recess 38 may be so defined that it is smaller slightly than an addition of the thickness of a pipe collar and a half of the thickness of the reinforcing ring 42.

An elastic gasket 10 or 44 may be a flexible rubber- or plastic-made, for example, it is made of polypropylene, polyester, polyamide, polyethylene, polyacetal or the like. It is preferable that corrosion resistant membrane is coated on the surface of the gasket when the fitting is built in a piping of a chemical plant, etc. The outside diameter of the elastic gaskets 10 or 44 may be substantially equal to the inside diameter of the reinforcing ring 8 or 42. This elastic gasket may be molded together with the reinforcing ring or may be mounted by inserting it in the ring. The elastic gasket becomes thinner to the thickness of the reinforcing ring when the thickness, namely, the axial width thereof decreases to 50 to 95% by compression.

The elastic gasket 10 or 44 is a rectangular cross section, as shown in FIG. 4 or 10. The elastic gasket has a groove 18 or 46 on the inner circumferential face thereof so that it is easy to be pressed against the reinforcing ring 8 or 42. The inner circumferential face of the elastic gasket 10 or 44 is substantially a V-shaped cross section. In this case, either the whole of the elastic gasket or only the inner circumferential face thereof may be a V-shaped cross section, this V-shaped section including a U-shaped, a semi-elliptic and a semicircular section. As for the cross section of the gasket, the outer circumferential face thereof is forced onto the inner circumferential face of the reinforcing ring more firmly than the sealing between the side face thereof and the surface of the pipe collar because the included angle of the groove is more than an angle of 90 degrees.

It is preferable that lips 23 and 23 are spread out inward in the transverse section of the elastic gasket 10 shown in FIG. 4. The heads of both the lips project outward from the side faces 20 and 20 of the gasket 10. Accordingly the side faces 20 and 20 of the gasket 10 tend to be pressed further on the surface of the pipe collar.

The reinforcing ring 8 or 42 is a thin circular-shaped, which may be made of stainless steel, carbon steel or cast steel. In case of the carbon steel-made or cast steel-made, it is possible to take anticorrosion measures such as zinc galvanizing, resin coating or the like. On the one reinforcing ring 8, at least one extension 24 (FIG. 3) may be extended therefrom, which is projected outward in the radial direction. The other reinforcing ring 42 may be applied together with flange 36 on which a recess 38 is formed, which is a simple ring body having the outside diameter that is substantially the same as that of the pipe collar 7 and the inside diameter that is larger than that of the pipe 3. The strength of this ring may be nearly equal to that of the connection pipe 3 against the tubeside inner pressure. Therefore the thickness T1 of the ring is substantially the same or larger as the thickness T2 of the connection pipe 3.

As for the reinforcing ring 8, a bolt-penetrating hole 12 is formed on the extension 24. The reinforcing ring 8 has, for example, two extensions 24 and 24 projected oppositely and outward in the radial direction and the hole 12 bored in each extension 24, as shown in FIG. 3.

The number of the extensions 24 of the ring 8 may be optionally decided according to the number and location of the bolt-penetrating holes 12 bored in the flange 2. It is, for instance, possible to arrange four extensions at 90° intervals or three extensions 24 at 120° intervals. When the extension 2 is gouged to form a hook-shaped head, the reinforcing ring 8 and the elastic gasket 10 can be attached even after connecting temporarily both the flanges 2 with the bolts 14. This hook-shaped extension is included among the holed extension.

In a case that a metal sheet is cut into the rings 8, they may be arranged in diagonal order so that the sheet is cut much efficiently even if the extensions 24 and 24 are projected out from each ring in the radial direction. If the extensions 24 and 24 are transformed somewhat from those shown in FIG. 3, it is possible that the consumed dimensions of the metal sheet about cutting of the rings are equal totally to those about cutting of conventional round packings. Since the ring 8 is not deformed on the occasion of locking with bolts 14, it is necessary that the surface thereof is fitted closely on the collar surface of the pipe 3, consequently a little clearance gap is sealed by compressive deformation of the elastic gasket 10.

As for the other reinforcing ring 42, it is also necessary that the surface thereof is fitted closely on the collar surface of the pipe 3 since the ring 42 is hardly deformed on the occasion of locking with bolts 14. It will be unnecessary to apply the reinforcing ring 42 to the fitting if both the surfaces of the flanges 36 and 36 are fitted perfectly on each other as shown in FIG. 7. It is actually necessary to arrange the ring 42 so that the gasket does not receive directly an expansion and contraction of the pipes. The reinforcing ring 42 may be integrated with the gasket by previous molding or may be fitted on the outside of the gasket by decreasing somewhat the caliber thereof.

The loose flange-type fitting 1 is assembled by fitting each conventional loose flange 2 onto the pipes 3, 3 and either flanging the edge of each pipe or welding a stub end 54 (see FIG. 11), as shown in FIG. 1. On this flanging, the collar 7 is formed squarely and outward on the one end of the pipe with a known flanging machine and similarly the other edge of the pipe is flanged in a pipe-processing factory or a piping place, for example, as disclosed in Japanese Patent No. 2810847. The reinforcing ring 8 and the elastic gasket 10 are interposed between end collar surfaces of the pipes 3 and subsequently both flanges 2 and 2 are connected to each other and locked up with the bolts 14 and nuts 16. It is also possible to attach a loose flange of two half segments on the pipe and fasten two half segments after flanging.

It is preferable that, for example, a tacking tool such as a ring band and the flange 2 are fitted onto the end of the pipe 3 and then the pipe is flanged. In a plumbing place, the collars 7 of the pipes 3, 3 laid out in the vertical and/or diagonal direction are brought close to locate accurately both the flanges 2, 2 and the tacking tool is positioned just behind the flange. It is possible to prevent the flange from falling off or slipping down with the tacking tool even if the flange is heavy. In a case that the pipes 3, 3 are laid out in the horizontal direction, the reinforcing ring can be accurately located by passing the bolt 14 through the open hole 12 of the ring 8 to connect the flanges temporarily to each other. Subsequently to completing this pipe connecting operation, it is necessary to fix the pipe 3 on a wall or like. On the occasion of this fixing operation, a stopper may be moved to the mounting position of a fastener such as a U-bolt (not shown) along the circumference face of the pipe and then stayed on the inside of the fastener. The fastener may be then tightened to fix the pipe 3.

In this loose-flange type fitting where the elastic gasket 10 and the reinforcing ring 8 are disposed, a supporting ring 32 (FIG. 6) may be also arranged on the inner side of the elastic gasket 10. The supporting ring 32 has a circular or rectangular section, which is made of a stainless steel, carbon steel or cast steel. The diameter of the supporting ring 32 is a little smaller than the inside diameter of elastic gasket 10, but it is larger than the inside diameter of the pipe 3. The thickness thereof may be equal or less to that of the reinforcing ring 8. The supporting ring 32 prevents the elastic gasket 10 from deforming inward when the tubeside pressure of the connection pipe 3,3 becomes negative, consequently it prevents a water leak from occurring.

### Effect of the Invention

The loose-flange type fitting according to the present invention is closely sealed with an elastic gasket that is relatively easy to be transformed by compression. It is therefore locked up by means of the bolts to such an extent that the connection between both the pipes endures a tubeside pressure. It is not necessary to lock up the gasket such strictly as a sheet packing. The loose-flange type fitting of the present invention has an annular reinforcing ring and the elastic gasket arranged between both collars of connection pipes, in which both sides and outer circumferential face of the elastic gasket are pressed against the pipe collars and a reinforcing ring so that the seal contact therebetween can increase in degree together with rising of a tubeside internal pressure.

The loose-flange type fitting of the present invention does not need to be locked excessively with bolts and nuts owing to this high sealing, which does not cause problems for the occurrence of a water leak when locking and in use. In the loose-flange type fitting, the number of the locking bolt may be reduced nearly in one half from a conventional fitting and the width and the outside diameter of the loose flange may be smaller relatively because hard locking with bolts and nuts is not necessary. It is easy to secure a workspace within the operation place, consequently pipe connecting works becomes easy.

The loose-flange type fitting does not cause the occurrence of a water leak under every condition because the gasket is not deformed inward and thus a sealing between both the pipes does not decrease in degree by arranging the supporting ring inside the elastic gasket even though the tubeside pressure becomes negative.

While both the loose flanges are connected to each other with several bolts and nuts, the reinforcing ring is disposed between the end faces of the pipe collars and then each bolt is passed through the open hole of the ring extension to lock both the flanges, therefore the reinforcing ring and the elastic gasket is prevented from off slipping down or falling. As the inside diameter of the elastic gasket is the same or larger than that of the connection pipes, circulating fluid can pass smoothly through the inside of the fitting.

### BRIEF DESCRIPTION OF THE DRAWINGS

FIG. 1 is a longitudinal sectional view illustrating one embodiment of a loose-flange type fitting according to the present invention.

FIG. 2 is a front view illustrating a loose flange useful for the fitting of FIG. 1.

FIG. 3 is a front view illustrating a reinforcing ring and an elastic gasket useful for the fitting of FIG. 1.

FIG. 4 is an enlarged sectional view showing a transverse section of the reinforcing ring and the elastic gasket of FIG. 3.

FIG. 5 is an enlarged sectional view illustrating the state where the elastic gasket of FIG. 4 is locked, and also showing a supporting ring in a modification of FIG. 6.

FIG. 6 is a longitudinal sectional view illustrating one modification of the fitting.

FIG. 7 is a longitudinal sectional view illustrating another modification of the fitting.

FIG. 8 is a front view illustrating a loose flange useful for the fitting of FIG. 7.

FIG. 9 is a front view illustrating a reinforcing ring and an elastic gasket useful for the fitting of FIG. 7.

FIG. 10 is an enlarged sectional view illustrating a transverse section of the reinforcing ring and the elastic gasket of FIG. 9.

FIG. 11 is a longitudinal sectional view illustrating a fitting assembly according to the present invention.

FIG. 12 is a sectional view illustrating the state where the fitting assembly of FIG. 11 is connected with both pipes.

FIG. 13 is a longitudinal sectional view illustrating a conventional loose-flange type fitting.

### EXPLANATIONS OF NUMERALS

1: loose-flange type fitting
2: loose flange
3, 3: connection pipe
5: bolt hole
7: pipe collar
8: reinforcing ring
10: elastic gasket
12: bolt-penetrating hole
14: bolt
16: nut
32: supporting ring

### PREFERRED EMBODIMENTS OF THE INVENTION

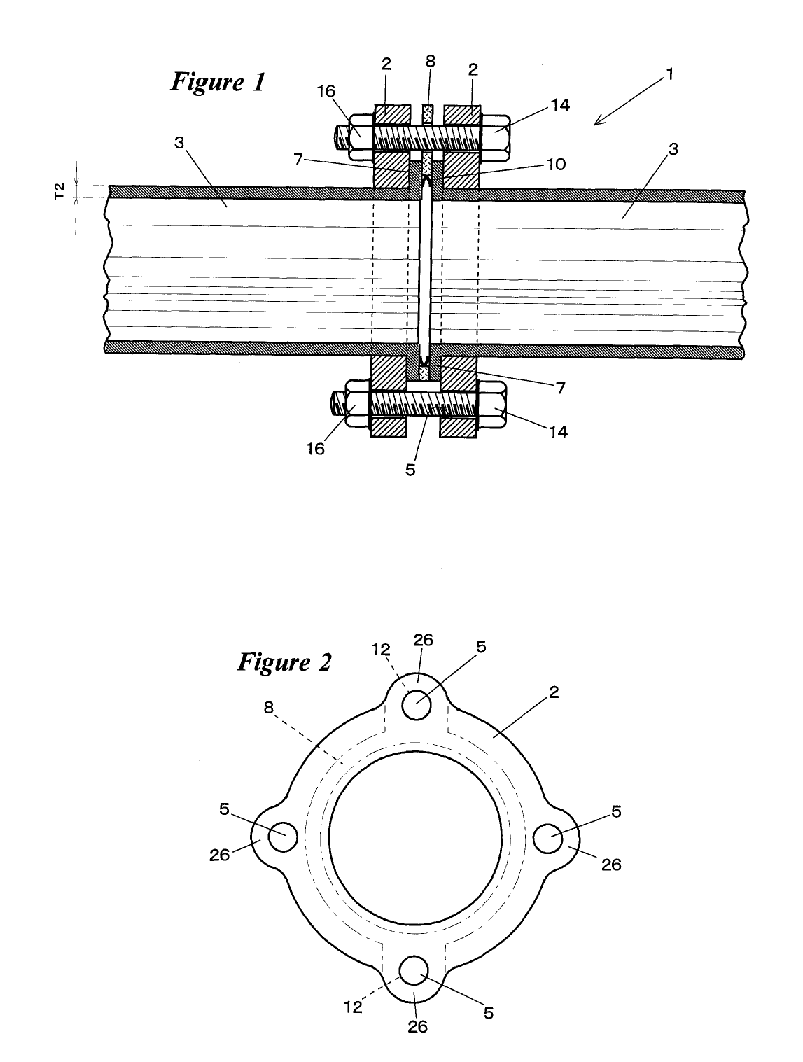

The present invention is now illustrated on the basis of examples, but the present invention will not be limited to the examples. In a loose-flange type fitting 1 illustrated in FIG. 1, metallic loose flanges 2 and 2 have substantially a doughnut-shaped plane as shown in FIG. 2, which is in existence separately from pipes 3 and 3 to be connected. The pipes 3 and 3 are a metallic conduit with like or corresponding diameter. On the flange 2, four bolt holes 5 are formed at regular intervals in the circumferential direction, whose inside diameter is substantially equal to the outside diameter of the pipe 3. The diameter of a virtual circle passing through the radial outside of the inner circumferential faces of each hole 5 is larger than the outside diameter of a collar 7 of the pipe 3 or a reinforcing ring 8.

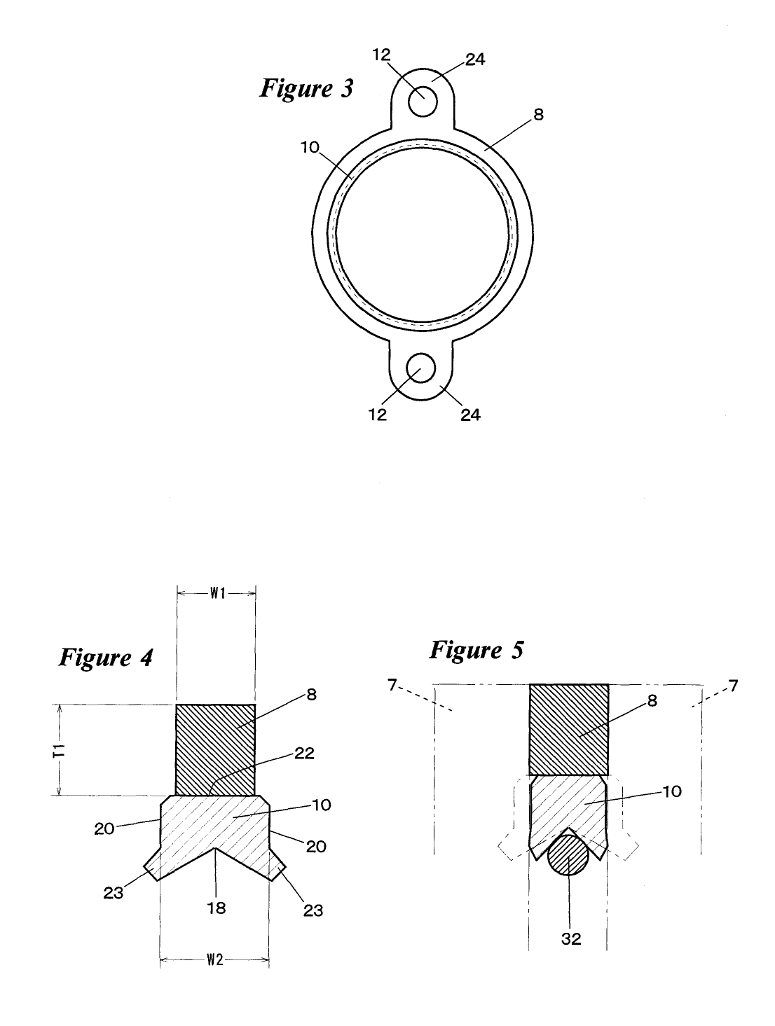

Each circular flange 2 is fitted onto the pipes 3 before flanging the pipe end. Instead of the circular flange 2, a loose flange of two half segments (not shown) may be attached on the pipe after flanging the pipe end. Both the pipes 3 and 3 are temporarily connected to each other by passing a bolt 14 through the hole 5 of the flange and an open hole 12 of the reinforcing ring 8 (see FIG. 3) and screwing a nut 16 onto the bolt 14 while the reinforcing ring 8 and the elastic gasket 10 are disposed between the pipe collars 7, 7 and then the end faces of two pipe collars 7, 7 are matched. The reinforcing ring 8 can be accurately located by passing each bolt 14 through two holes 12, subsequently four bolts 14 are tightened with each nut 16, respectively.

An elastic gasket 10 is made of high-elastic rubber or plastics, whose cross-section is a rectangle having lips 23 and 23 arranged in substantially V-shaped, as shown in FIG. 4. The elastic gasket 10 is so defined that the outside diameter thereof is substantially equal to the inside diameter of the reinforcing ring 8 and the inside diameter thereof is similar or somewhat larger than the inside diameter of the pipe 3, 3 to be connected.

As for the elastic gasket 10, the transverse section thereof is a rectangle having substantially V-shaped lips 23, 23 so that the inner central portion of the section is dented slightly. With a tubeside pressure concentration through this groove 18 (FIG. 4), the side faces 20 and 20 of the elastic gasket 10 tend to be pressed on the surface of each pipe collar and the outer circumferential face 22 thereof tends to be pressed against the reinforcing ring 8. Since both the lips 23 and 23 are spread out inward so that the distance between the heads thereof is broader than the axial width W2 of the gasket 10 in the cross-section thereof, the side faces 20 and 20 of the gasket 10 tend to be pressed further on the surface of the pipe collar.

The reinforcing annular ring 8 has a rectangular section, as shown in FIG. 1 or 4. The ring 8 is made of stainless steel, carbon steel or cast steel. In case of the carbon steel-made or cast steel-made, it is possible to take anticorrosion measures such as zinc galvanizing, resin coating or the like. As shown in FIG. 3, two extensions 24 and 24 are extended from the ring 8, which are projected outward in the opposite radial direction and in which each round bolt-penetrating hole 12 is bored in the center thereof. The extension 24 is a tongue-shaped plate having a semicircular periphery.

About the reinforcing ring 8, the axial width W1 thereof is a distance that subtracts a compressed portion of the elastic gasket 8 from the axial width W2 of the gasket 10, which is generally defined as 50 to 95% of the axial width W2 of the gasket 10 (see FIG. 5). The axial width W1 approaches to 75% of the axial width W2 when the gasket 10 is relatively soft and approaches to 95% of the axial width W2 when the gasket 10 is relatively hard. The outside diameter of the ring 8 is substantially equal to the outside diameter of the pipe collar 7 and also the inside diameter of the ring 8 is larger than the inside diameter of the pipe 3.

It is preferable that the reinforcing ring 8 has substantially the same or more strength as the connection pipe 3 against a tubeside pressure. It is therefore so defined that the thickness T1 of the reinforcing ring 8 is substantially equal or more to the thickness T2 of the connection pipe 3.

The loose-flange type fitting 1 is locked up with the bolts 14 to such an extent that the connection between the pipes 3, 3 endures a tubeside pressure because the collars 7, 7 are closely fitted via the elastic gasket 10 that is relatively easy to be transformed by compression, as shown in FIG. 5. It is not necessary to tighten it excessively like the usual sheet packing. It is therefore possible that the number of the locking bolts is reduced nearly to half in comparison with a conventional fitting. It is also possible to reduce the area on the fitting face of the pipe collars 7, 7 so that the outside diameter of the pipe collar 7 may be smaller than before. About the flange 2 having four bolt holes 5, the outside diameter and the thickness thereof are smaller than those of the previous flange 100 shown in FIG. 13 even if the inside diameter thereof is nearly equal to the outside diameter of the connection pipe 3. It possible to make dents in the circumference of the flange 2 except portions 26 where the bolt holes 5 exist, as shown in FIG. 2, so that the whole area of the fitting 1 becomes compact and thus miniaturization can be achieved.

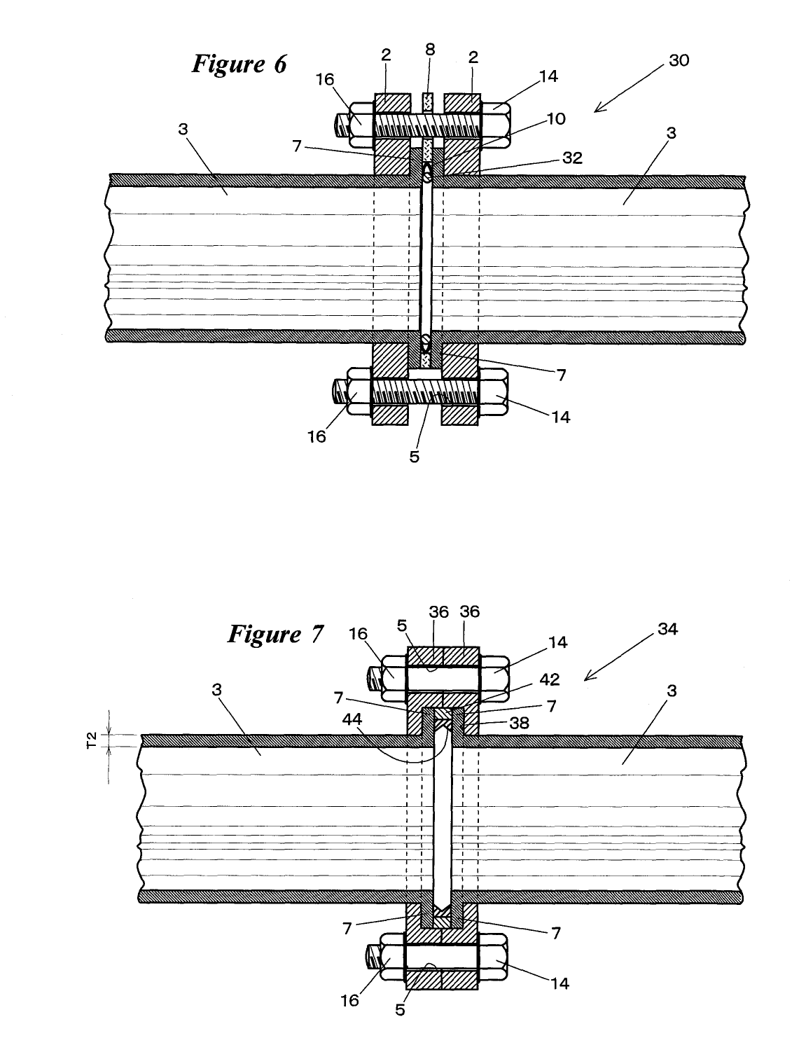

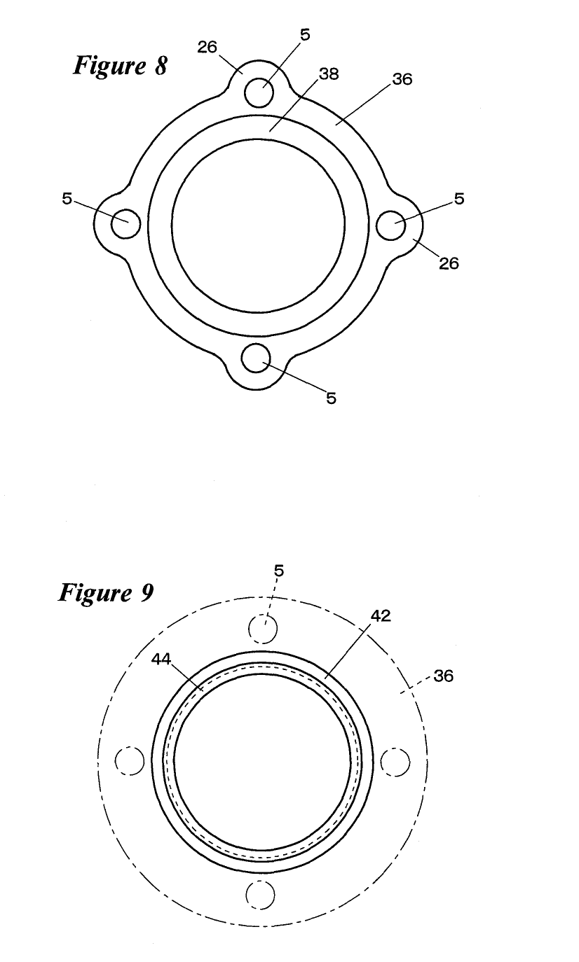

A modification of the present invention is illustrated in FIG. 6. In a loose-flange type fitting 30, an elastic gasket 10 and a reinforcing ring 8 are disposed as a seal material and also a supporting ring 32 (see FIG. 5) with an annular cross-section may be arranged on the inner circumferential side of the elastic gasket 10. The supporting ring 32 may be made of stainless steel, carbon steel or cast steel. In case of the carbon steel-made or cast steel-made, there are taken anticorrosion measures such as zinc galvanizing, resin coating or the like. The diameter of the supporting ring 32 is slightly smaller than the inside diameter of the elastic gasket 10 and the thickness thereof is similar to or less than the thickness of the reinforcing ring 8.

The supporting ring 32 prevents a water leak by keeping the elastic gasket 10 from inward deformation when the inside of the connection pipes 3 and 3 falls down to negative pressure. It is preferable that the supporting ring 32 with an annular cross section is inserted in the groove 18 of the elastic gasket 10, as shown in FIG. 5, and therefore it prevents the gasket 10 much effectively from deformation.

FIG. 7 shows another modification of the present invention, in which like reference characters are used for the same or corresponding parts as the above-mentioned embodiment. In a loose-flange type fitting 34 shown in FIG. 7, a round recess 38 is formed concentrically on the inside faces of a metallic loose flanges 36 and 36, respectively. On the loose flange 36, four bolt holes 5 are formed at regular intervals in the circumferential direction outside the round recess 38.

As for the loose flange 36, the diameter of a central open hole is substantially equal to the outside diameter of pipe 3 to be connected. The round recess 38 is so defined that the diameter thereof is substantially equal to the outside diameter of the pipe collar 7 and the outside diameter of a reinforcing ring 42. The depth of the round recess 38 is also smaller slightly than an addition of the thickness of a pipe collar 7 and a half of the thickness of the reinforcing ring 42 (see FIG. 7).

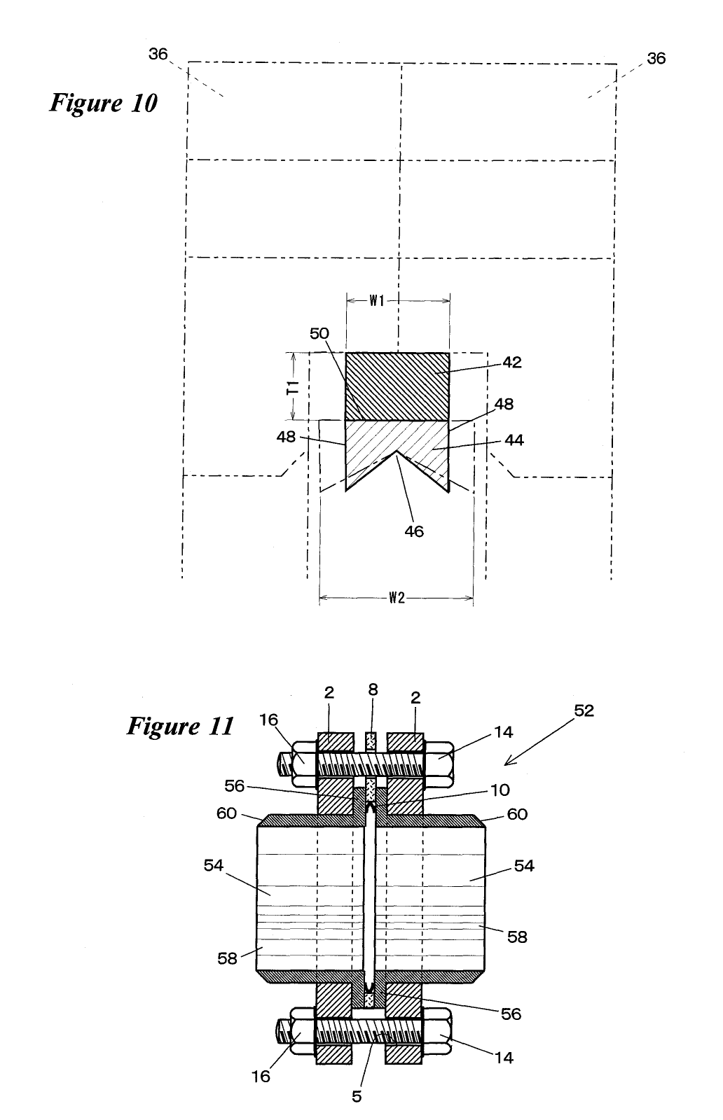

The reinforcing annular ring 42 has an elongated rectangular section, as shown in FIG. 7 or 10. As for the reinforcing ring 42, the outside diameter thereof is substantially equal to the outside diameter of the pipe collar 7 and the inside diameter thereof is larger than the inside diameter of the connection pipe 3. It is defined that the thickness T1 of the reinforcing ring 42 is substantially equal to or more than the thickness T2 of the connection pipe 3 so that the ring 42 has substantially the same or more strength as the connection pipe 3 against a tubeside pressure. The axial width W1 of the ring 42 is a distance that subtracts a compressed portion of the elastic gasket 44 from the axial width W2 of the gasket 44, which is generally defined as 50 to 95% of the axial width W2 of the gasket 44 (see FIG. 10).

As shown in FIG. 10, the transverse section of the elastic gasket 44 is substantially a rectangle, whose inner circumferential face is a V-shaped. By the groove 46 of the elastic gasket 44, the side faces 48 and 48 thereof tend to be pressed on the surface of each pipe collar 7 and the outer circumferential face 50 thereof tends to be pressed against the reinforcing ring 42 with a tubeside pressure concentration. On the traverse section of the gasket 44, the outer circumferential face 50 thereof is closely fitted more than the side faces 48 and 48 thereof since the V-shaped included angle exceeds generally 90°.

Both the pipes 3 and 3 are connected to each other by placing the reinforcing ring 42 and the elastic gasket 44 therebetween, matching the end faces of two pipe collars 7, 7, passing four bolts 14 through each hole 5 of both the loose flanges and screwing each nut 16 onto the bolts 14. The pipe collars 7 are then inserted in a round recess 38 of the loose flanges 36 and subsequently four bolts 14 are tightened with each nut 16.

The loose-flange type fitting 34 is locked up by means of the bolts 14 only has to such an extent that the connection between the pipes 3, 3 endures a tubeside pressure because the collars 7, 7 are closely fitted via the elastic gasket 10 that is relatively easy to be transformed by compression, as shown in FIG. 7. It is therefore possible that the number of the locking bolts is reduced nearly to half in comparison with a conventional fitting. It is also possible to reduce the area on the fitting face of the pipe collars 7 than before. About the flange 36 having four bolt holes 5, the inside diameter thereof is nearly equal to the outside diameter of the connection pipe 3. It possible to make dents in the circumference of the flange except portions 26 where the bolt holes 5 exist, as shown in FIG. 2,

FIG. 11 shows one embodiment of a fitting assembly, in which like reference characters are used for the same or corresponding parts as the above-mentioned embodiments. The fitting assembly 52 is provided with one couple of metallic stub ends 54 and 54 having like diameter, which is so arranged that the collars 56 of both stub ends 54, 54 are opposed to each other. The stub end 54 is composed of the collar 56 and a cylinder 58 whose diameter is smaller than the outside diameter of the collar 56 and whose circumferential edge 60 is chamfered. On the circular loose flange 2, four bolt holes 5 are formed at equal intervals in the circumferential direction.

Each flange 2 is fitted onto the pipes 3 respectively. Both the stub ends 54 and 54 are temporarily connected to each other by placing the reinforcing ring 8 and the elastic gasket 10 between the pipe collars 56, 56, matching the end faces of two pipe collars 56, 56, passing a bolt 14 through the hole 5 of the flange and an open hole 12 of the reinforcing ring 8 and screwing a nut 16 onto the bolt 14. The reinforcing ring 8 can be accurately located by passing each bolt 14 through two holes 12 thereof and subsequently all bolts 14 are tightened with each nut 16.

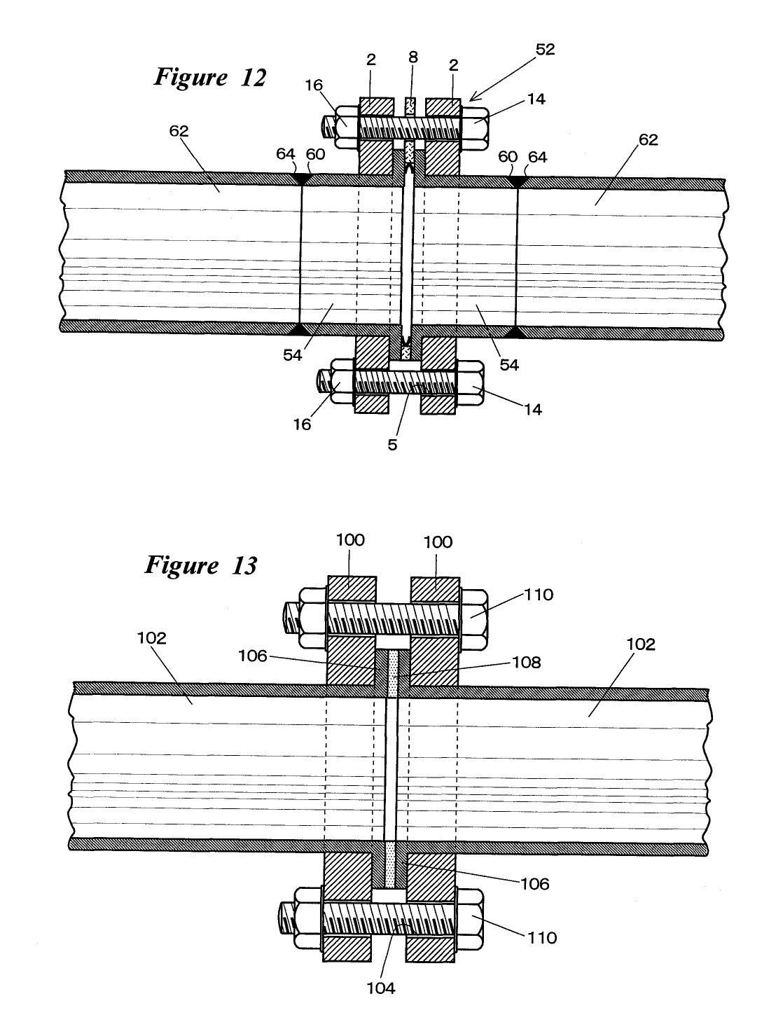

The fitting assembly 52 is sold in the form of FIG. 11 where nuts 16 are screwed lightly. Plural types of the fitting assembly 52 are also sold, in which each bore diameter of the stub end is matched to the caliber of commercial pipes. Before the connection with the fitting assembly 52, it is desirable to chamfer the end face of a pipe 62 to be connected. On the occasion of installing the fitting assembly 52, the chamfered circumferential face 64 of each pipe 62 is adjusted to the chamfered circumferential face of the stub end 54 to weld the stub end 54 to the pipe end. The fitting assembly 52 is then built in by locking up the bolts 14 and nuts 16, as shown in FIG. 12.

When applying the fitting assembly 52 shown in FIG. 11 to a small-scale plumbing, the work can be achieved easily and promptly by assembling one or more loose flange fittings. A partial exchange or a periodic repair of the existing pipes can be also carried out easily by putting the assembly in the existing piping equipment. It is possible to sell inexpensively the fitting assembly 52 by mass-production as universal assembly.

What is claimed is:

1. A loose-flange type fitting, in which each edge of both pipes is flanged or each stub end is welded to the ends thereof and then both fitted loose flanges are connected and locked to each other while a seal material is arranged between the end faces of both the pipes, the seal material comprising:
an annular elastic gasket;
a metallic reinforcing ring disposed on the outer circumferential side of the elastic gasket; and
the inner circumferential face of the elastic gasket having substantially a V-shaped cross-section and the axial width of the gasket being broader than that of the reinforcing ring under non-compression conditions.

2. A fitting as recited in claim 1, in which the transverse section of the elastic gasket is a rectangle having V-shaped lips on the inner circumferential side thereof.

3. A fitting as recited in claim 1, in which the reinforcing ring has a rectangular section, whose axial width is smaller than that of the elastic gasket by compression of the gasket, the axial width thereof being 50 to 95% of that of the gasket.

4. A fitting as recited in claim 1, in which the thickness of the reinforcing ring is defined as a thickness having the same or higher strength as the thickness of the connection pipe.

5. A fitting as recited in claim 1, in which at least one extension that projects outward in the diametric direction is formed on the reinforcing ring, a bolt-penetrating hole being bored in the extension.

6. A fitting as recited in claim 5, in which two extensions that project outwards in the diametric direction are formed in the reinforcing ring, each bolt-penetrating hole being bored in the extensions.

7. A fitting as recited in claim 1, in which each round recess is formed on the inner end face of the loose flanges, the depth of the round recess being substantially equal or smaller to the addition of the thickness of the pipe collar and a half of the thickness of the reinforcing ring.

8. A fitting as recited in claim 7, in which both the loose flanges are locked while each pipe collar is inserted in the round recess of the loose flange and then the elastic gasket and the reinforcing ring are arranged between two collars when assembling.

9. A fitting as recited in claim 7, in which the reinforcing ring is made of a material selected from the group consisting of stainless steel, carbon steel and cast steel.

10. A fitting as recited in claim 1, in which the elastic gasket is made of a material selected from the group consisting of rubber and plastics.

11. A fitting as recited in claim 1, in which a metallic supporting ring is disposed on the inner circumferential side of the elastic gasket so that it prevents the elastic gasket from being deformed inward.

12. A fitting as recited in claim 11, in which the supporting ring is made of a material selected from the group consisting of stainless steel, carbon steel and cast steel, the supporting ring having a circular or rectangular cross-section.

13. A fitting assembly, in which a seal material is arranged between collars of both stub ends and then both fitted loose flanges are connected and locked to each other, the seal material comprising:
an annular elastic gasket;
a metallic reinforcing ring disposed on the outer circumferential side of the elastic gasket; and
the inner circumferential face of the elastic gasket having substantially a V-shaped cross-section and the axial width of the gasket being broader than that of the reinforcing ring under non-compression conditions,
both the stub ends being finally welded to the ends of the pipes, whereby the fitting assembly is built in a plumbing arrangement.
